(19) United States
(12) Patent Application Publication
(10) Pub. No.: US 2002/0018081 A1
(43) Pub. Date: Feb. 14, 2002

(54) DRUM TYPE HARD COPY APPARATUS

(75) Inventors: PRESTON DOW SEU, VANCOUVER, WA (US); DAVID J. LOWE, VANCOUVER, WA (US); CLEMENT C. LO, LAKE OSWEGO, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD COMPANY

(21) Appl. No.: 09/370,722

(22) Filed: Aug. 9, 1999

(51) Int. Cl. G01D 15/24

(52) U.S. Cl. 346/136

(57) ABSTRACT

A printing media cartridge for a drum-type hard copy apparatus has printing media supply within the drum. Printable sheet lengths of printing medium are extracted from the interior of the drum through a slot such that individual prints can be produced using the drum outer surface as a platen. Removing a print from the platen extracts the next sheet length from within the drum which is then automatically wrapped back onto the drum's outer surface and aligned for the next print cycle. Printer control encoding is provided with the cartridge.

### BACKGROUND OF THE INVENTION

1. Field of the Invention

The present invention relates generally to hard copy printing and more specifically to a methods and devices for containing and feeding printing media in a drum type hard copy apparatus.

2. Description of Related Art

The art of hard copy printing technology is well developed in commercial products such as computer printers, graphics plotters, copiers, and facsimile machines. One specific type of hard copy printing employs ink-jet technology for producing the hard copy. The basics of this technology are disclosed, for example, in various articles in the Hewlett-Packard Journal, Vol. 36, No. 5 (May 1985), Vol. 39, No. 4 (August 1988), Vol. 39, No. 5 (October 1988), Vol. 43, No. 4 (August 1992), Vol. 43, No. 6 (December 1992) and Vol. 45, No. 1 (February 1994) editions. Ink-jet devices are also described by W. J. Lloyd and H. T. Taub in Output Hardcopy [sic] Devices, chapter 13 (Ed. R. C. Durbeck and S. Sherr, Academic Press, San Diego, 1988). In order to explain the present invention, a ink-jet hard copy apparatus will be used as an exemplary embodiment. As the present invention may be extended to other forms of printing, no limitation on the scope of the invention is intended by the use of this exemplary embodiment nor should any such intention be implied.

FIG. 1 (PRIOR ART) depicts an ink-jet hard copy apparatus (with its cover shell removed, in this exemplary embodiment a computer peripheral printer, 101. A housing 103 encloses the electrical and mechanical operating mechanisms of the printer 101. Operation is administrated by an electronic controller 102, usually a microprocessor or application specific integrated circuit (“ASIC”) controlled printed circuit board connected by appropriate cabling to a computer (not shown). It is well known to program and execute imaging, printing, print media handling, control functions and logic with firmware or software instructions for conventional or general purpose microprocessors or with ASIC's. Cut-sheet print media 105, loaded by the end-user onto an input tray 120, is fed by a suitable paper-path transport mechanism (not shown) to an internal printing station, or printing zone, 107 where graphical images or alphanumeric text is created. A carriage 109, mounted on a slider 111, scans the print medium. An encoder 113 is provided for keeping track of the position of the carriage 109 at any given time. At least one, or a set, of individual ink-jet pens, or print cartridges, 115_{X} are releasable mounted in the carriage 109 for easy access. Generally, in a full color system, inks for the subtractive primary colors—cyan, yellow, magenta (CYM)—and true black (K) (F standing for a fixer fluid) are provided in remote, or “off-axis,” replaceable or refillable, ink reservoirs 117_{X} having fluidic couplings 119 to the pens 115_{X}. Once a printed page is completed, the print medium is ejected onto an output tray 121. It is common in the art to refer to the pen scanning direction as the x-axis, the paper feed direction as the y-axis, and the ink drop firing direction as the z-axis.

Hard copy apparatus, be it in the form of a printer, plotter, copier, scanner, facsimile machine, or the like, share the need for having a blank printing media supply, preferably in an automated-feeder device appurtenant to the hard copy apparatus. In turn, printing media come in a variety of forms. A common computer printer 101, such as a Hewlett-Packard™ DeskJet™ ink-jet printer as depicted in FIG. 1, is usually designed to be compatible with a variety of media, such as plain paper, special paper, transparencies, and envelopes, up to and including legal size (8.5×14-inches) media as are commonly used in an office or home environment. On the other hand, a common large format plotter 201, such as an ink-jet plotter like the Hewlett-Packard DesignJet™ series illustrated by FIG. 2 (Prior Art), requires accommodation for large sheets, or continuous, media 203, currently up to eighty inches in the scanning x-axis width dimension. As the computing arts expand into new fields, such as palm top computers or specialized computer printing needs, such as dedicated photograph ink printing as in the Hewlett-Packard PhotoSmart™ digital camera 300 direct printer 303 series depicted by FIG. 3 (Prior Art), other sizes of printing media (e.g., 3.5×5 for photographs) and other forms of recording media, such as cloth (e.g., for ink printing on T-shirts) and advanced automated-feeder devices are needed.

Herein, the terms “recording” and “printing” are used synonymously, intended to include the action of applying any type of colorant (e.g., ink, toner, and the like) to any kind of printing medium (e.g., paper, cloth, plastic, flexible materials, and the like)—referred to hereinafter generically as “paper”—and any kind of hard copy producing apparatus—referred to hereinafter generically as a “printer.”

One specific type of hard copy apparatus is generically referred to as a “drum printer.” A schematic depiction of a drum printer 401 is shown in FIG. 4 (Prior Art). The operational functions of the printer are administered by an electronic controller 402, as would be known in the art, coupled to an input/output device 400, such as a computing apparatus. A drum printer 401 wraps a sheet of paper 403 from a provided supply 405 around a rotating cylinder 407 which then acts as a paper platen. A writing instrument 409 is located parallel to the drum surface or has a carriage (not shown), carrying one or more writing instruments as demonstrated by FIGS. 1 and 2, that travels along an axis parallel to the cylinder's rotational axis. In a scanning carriage type drum printer, both carriage and drum velocities are held constant during printing to keep power consumption low and reduce dynamic operational problems, such as accounting for carriage reversal acceleration and deceleration ramp distances and durations during a print cycle. In general, drum printers have a higher throughput (“pages per minute” or “ppm”) than flat bed scanning carriage printers such as shown in FIGS. 1 and 2.

Drum printers have design variations such as having a less than “page wide”, “W,” writing instrument stationary while the medium 403 rotates with the cylinder 407, moving the writing instrument only between printing each successive swath. Having the writing instrument stationary provides inherent print quality enhancing capabilities. The medium 403 does not cover the entire circumference of the drum; that is a gap, “G,” separates the medium's leading edge 411 and trailing edge 413. The writing instrument is shifted quickly to start printing a next swath while this gap on the drum is passing. In another design variation, helical scanning by a writing instrument can be provided by slowing scanning the writing instrument carriage while the drum rotates or by translating the drum relative to a stationary writing instrument.

A main problem with drum printers is the loading and holding of the medium to the cylinder surface. Print quality may be degraded by variations of the medium registration to the drum surface. Manual taping or clamping is cumbersome and time consuming. Automated pick-and-feed mechanisms associated with an input tray combined with mechanical or electromechanical edge clamping devices improve the loading cycle time and eliminate the need for user intervention. Such mechanisms add significant complexity and cost to manufacture. Automated pick-and-feed mechanisms associated with an input tray combined with vacuum holddown cylinder drum printers are also known. Such vacuum systems also add significant complexity and cost to manufacture. Moreover, localized suction forces from the pattern of vacuum through-holes in the cylinder surface are generally transmitted through the printing medium and thus also can effect the print quality. Both automated clamping and vacuum systems compromise the desire for a small workplace footprint. Mechanical clamping requires precise timing. Vacuum systems require costly exhaust systems which also require a significant power supply.

All of the foregoing shortcomings of the prior solutions are exacerbated by the need to accommodate multiple printing media sizes. Mechanical holddowns may require segmented clamps coordinated with the current medium in use. Smaller width media on a vacuum holddown leaves vacuum ports in the cylinder uncovered, changing the suction flow dynamic. Maintaining the pressure difference necessary to hold the medium to the surface requires either higher air flow or adaptive mechanisms for closing uncovered ports.

There is a need for methods and devices for storing and holding printing media for a drum printer.

### SUMMARY OF THE INVENTION

In a basic aspect, the present invention provides a print media cartridge device including: a supply of print media in a format such as a substantially cylindrical roll; a containing mechanism for containing the supply of print media in an interior chamber of the containing mechanism, wherein the containing mechanism is a substantially cylindrical construct having an outer surface for sequentially receiving at least one sheet of the supply thereon from within the containing mechanism via an aperture coupling the outer surface to the interior chamber; and mounting mechanism for mounting the print media cartridge device adjacent mechanisms for printing on the print media of a hard copy apparatus adapted for using the device.

In another basic aspect, the present invention provides a hard copy apparatus including: a writing instrument; mounted adjacently to the writing instrument, a removable, rotating drum platen having an outer surface, the outer surface including an aperture of a width sufficient for passing print media therethrough; a supply of print media contained within the drum in an orientation for continuously, sequentially feeding print media through the aperture such that at least one sheet length of the print media is wrapped around the drum platen when extracted from the drum; at least one mechanism for temporarily securing a leading edge of the sheet length wrapped around the drum platen to the outer surface such that the sheet length is positioned with respect to the writing instrument for receiving colorant therefrom; associated with the drum platen, at least one mechanism for encoding printing operation information; and associated with the writing instrument, at least one mechanism for recognizing the information.

In another basic aspect, the present invention provides a method of providing print media to a rotating drum type hard copy apparatus including the steps of: providing the apparatus with a replaceable rotating drum construct mountable on the apparatus and having a supply of print media contained within the drum construct, wherein the supply of print media is in a form such that the media is extractable from within the drum construct via an aperture in an outer surface of the drum, the outer surface configured for holding predetermined lengths of the media extracted from within the drum construct such that the surface forms a printing platen in the apparatus; and periodically replacing the rotating drum construct with a rotating drum construct cartridge having a replacement supply of print media therein.

In another basic aspect, the present invention provides a method of providing print media to a rotating drum type hard copy apparatus including the steps of: providing the apparatus with a refillable rotating drum construct mountable on the apparatus and having a supply of printing media contained within the drum construct, wherein the supply of printing media is in a form wherein the media is extractable from within the drum construct via an aperture in an outer surface of the drum, the outer surface configured for holding predetermined lengths of the media extracted from within the drum construct such that the surface forms a printing platen in the apparatus; and periodically replacing the supply of printing media drum within construct with a replacement supply of print media therein.

In another basic aspect, the present invention provides a method of producing hard copy including the steps of:

a) providing a drum platen with an internal supply of a continuous printing medium;

b) extracting through the drum platen a first length of printing medium from the supply by a leading edge;

c) wrapping the first length about the drum platen;

d) securing the leading edge of the first length to the drum platen proximate a trailing edge of the first length;

e) printing on the first length by rotating the drum platen in a first direction passed a writing instrument;

f) releasing the leading edge;

g) pulling the first length away from the drum platen wherein the drum platen is rotated in a second direction opposite the first direction;

h) stop locking the drum platen in a predetermined position wherein the step of pulling further extracts a next length of printing medium from within the drum platen;

i) separating the first length from the next length;

j) rotating the drum platen in the first direction such that the next length is wrapped around the drum platen;

k) securing the leading edge of the next length to the drum platen proximate a trailing edge of the next length; and

l) repeating steps e) through k) for each hard copy to be produced.

Some advantages of the present invention are:

the present invention provides a compact and low cost printing media cartridge for a drum printer;

the present invention provides a disposable or reloadable printing media cartridge having recognizable encoding for printing operation controls;

the present invention provides a printing media cartridge that also serves as a drum platen for a drum printer;

the present invention provides a simple mechanism for loading a recording medium into a hard copy apparatus;

the present invention provides a disposable mechanism for loading a recording medium into a hard copy apparatus;

the present invention provides a replaceable mechanism for loading a recording medium into a hard copy apparatus;

the present invention provides manufacturer-loadedable, reliable printing medium supplies;

the present invention provides a mechanism for encoding printing medium types and printing characteristics, automatically recognizable by a hard copy apparatus;

the present invention provides for a printing medium encoding scheme that can use the same sensor used for drum speed control; and

the present invention provides for a low cost solution to drum printer supply and loading procedures.

The foregoing brief summary of the basic aspects of the invention and list of advantages is not intended by the inventors to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01(d) merely to apprize the public, and more especially those interested in the particular art to which the invention relates, of the nature of the invention in order to be of assistance in aiding ready understanding of the patent in future searches. Other objects, features and advantages of the present invention will become apparent upon consideration of the following explanation and the accompanying drawings, in which like reference designations represent like features throughout the drawings.

### BRIEF DESCRIPTION OF THE DRAWINGS

FIG. 1 (Prior Art) is a perspective view illustration of a computer printer.

FIG. 2 (Prior Art) is a perspective view illustration of a computer plotter.

FIG. 3 (Prior Art) is a perspective view illustration of a small paper format, dedicated, digital photograph printer.

FIG. 4 (Prior Art) is a schematic depiction of a drum printer.

FIG. 5 is a schematic depiction, perspective view of a printing media drum cartridge in accordance with the present invention.

FIG. 6 is a cross-sectional view of the present invention taken in a radial plane R-R as shown in FIG. 5.

FIGS. 7A and 7B are planar view of the present invention as shown in FIG. 5 as oriented with an exemplary printhead in which:

FIG. 7A is a top view, and

FIG. 7B is a side view.

FIG. 8 is a schematic depiction of markings used to supply print media and timing information to a printer controller and driver software.

FIGS. 9A through 9G are schematic representations of the methodology of the present invention.

The drawings referred to in this specification should be understood as not being drawn to scale except if specifically noted.

### DESCRIPTION OF THE PREFERRED EMBODIMENT

Reference is made now in detail to a specific embodiment of the present invention, which illustrates the best mode presently contemplated by the inventors for practicing the invention. Alternative embodiments are also briefly described as applicable. Again, for convenience and to simplify the description, the present invention is detailed with respect to an exemplary embodiment for an ink-jet hard copy apparatus. No limitation on the scope of the invention is intended by the use of this exemplary embodiment nor should an be implied therefrom.

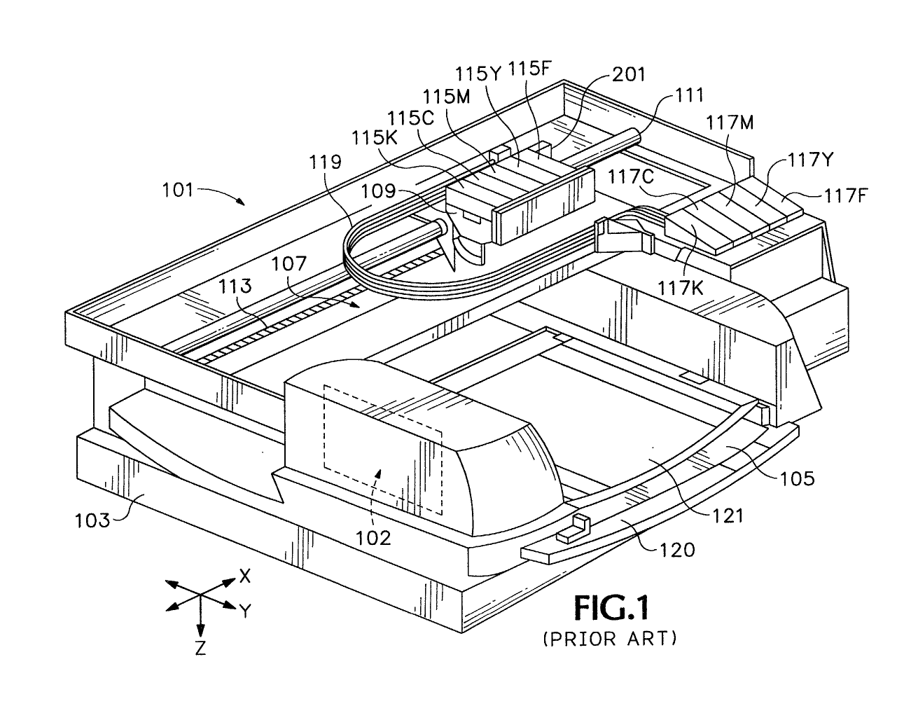

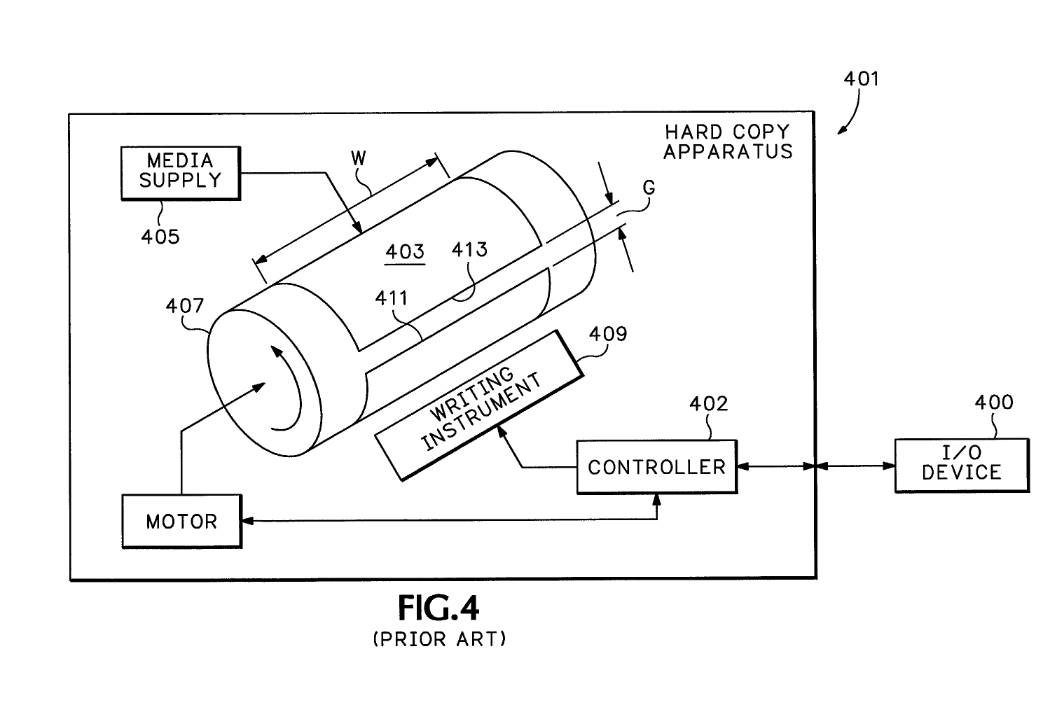

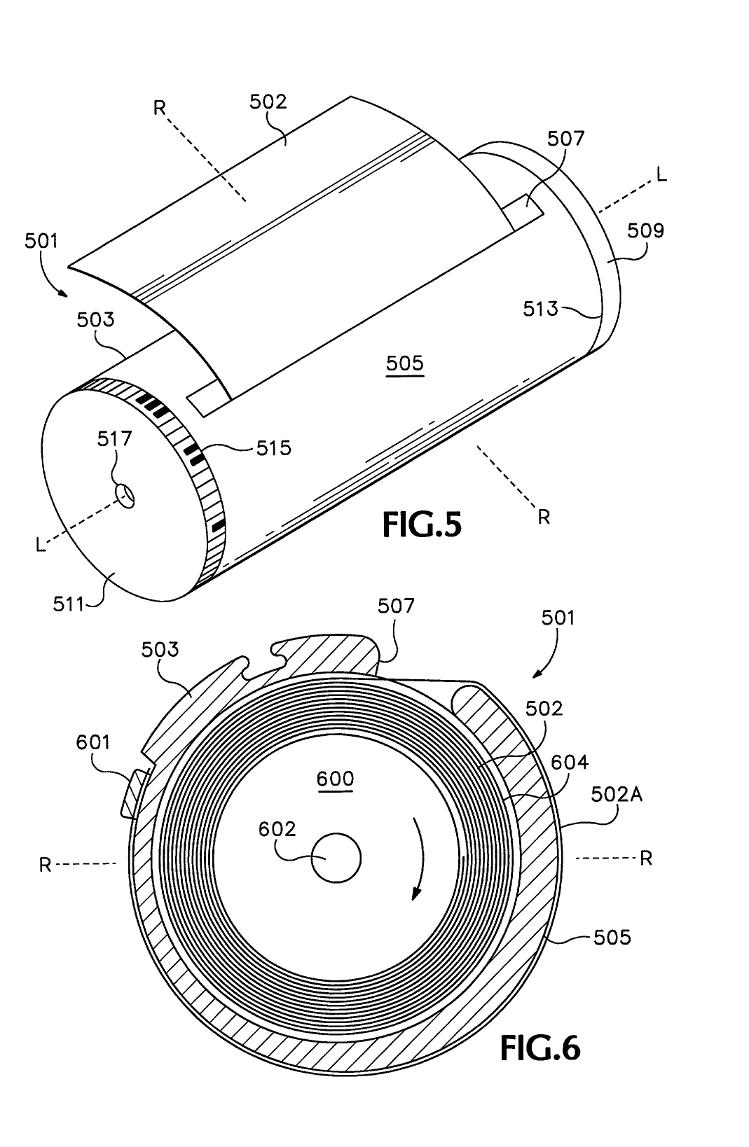

FIG. 5 illustrates a printing medium drum cartridge 501 in accordance with the present invention. The physical dimensions of the cartridge 501 will vary proportionately with the size - both width and length, where the length relates to the volume of the supply-and type of paper supply 502 employed therewith. The cartridge 501 has a generally cylindrical barrel 503, having an outer surface 505. The barrel 503 is characterized by an aperture, or slot, 507, therethrough. The slot 507 is parallel to the longitudinal axis (“L-L”) of the cylindrical barrel 503, which is also the axis of rotation of the drum cartridge 501. The slot 507 has an axial length sufficient for allowing a predetermined width of paper 502 to pass therethrough. Two end caps 509, 511—which may be removable for a reloadable implementation—provide closures for the two respective ends 513, 515 of the cylindrical barrel 503, having a central aperture 517 for receiving an axle of a printing medium drum cartridge adapted printer, e.g., adaptations of FIGS. 1-4. The outer surface 505 serves as a drum platen for the printer in which the drum cartridge 501 is installed (see FIG. 4). The cartridge 501 can be manufactured to be a one-time use, disposable unit or reusable.

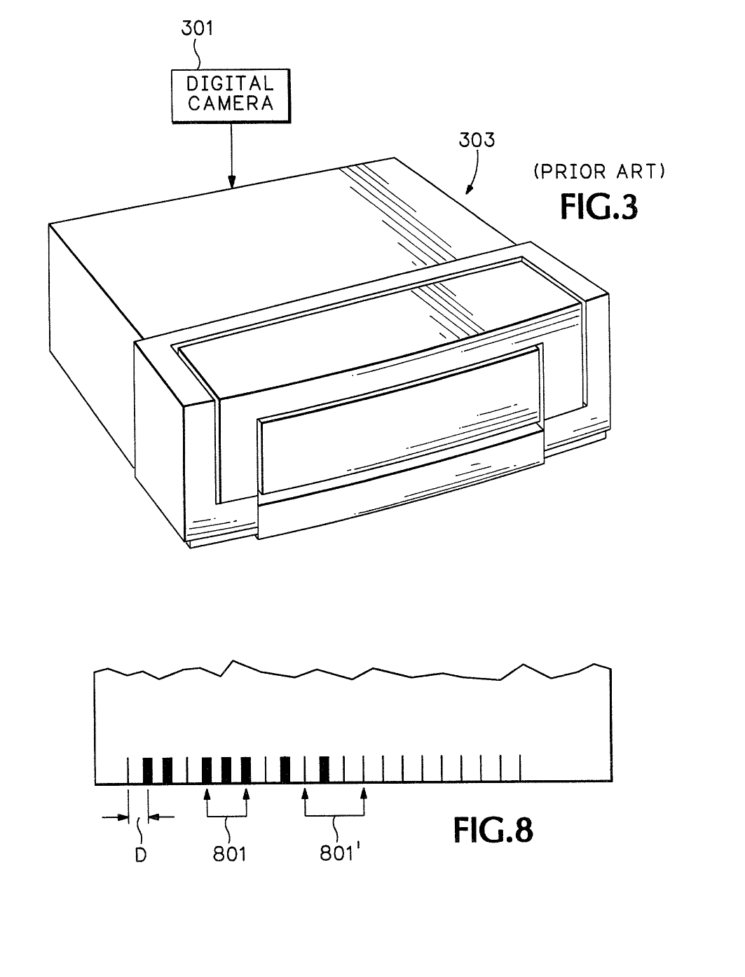

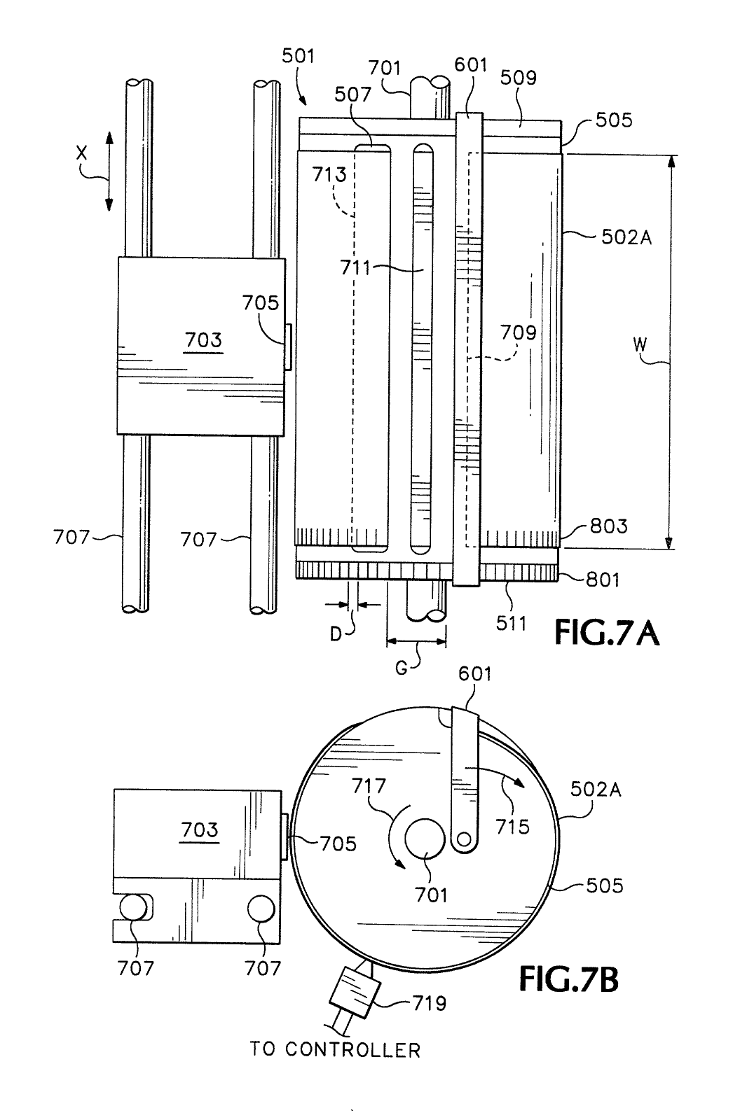

FIG. 6 depicts the cartridge 501 in a cross-sectional aspect (radial plane “R-R,” FIG. 5). The paper supply 502 is contained in a rolled configuration about a hub 600 inside of the barrel 503. Other media containment configurations, e.g., fan-fold and the like as would be known in the art can be implemented to suit a particular design implementation. The inner surface of the barrel 503 and the outer surface of the paper supply hub 600 form a chamber that holds the paper supply 502. The depiction shows a length of paper 502A that has been extracted from the chamber and wrapped about a segment of the circumference of the drum surface 505 equivalent to the length, e.g., for a photo-printer (FIG. 3), approximately five inches from leading edge to trailing edge. The extracted length 502A is thus positioned for printing with the drum surface 505 acting as a platen. Note that the print media supply 502 can be a continuous roll, or a segmented roll of paper separated by tear perforations, or a compressed, rolled series of cut sheets that are releasably held together (e.g., with a releasable glue) for separation after initial extraction, wrap about the platen, and printing, or the like as may be employed in accordance with any specific implementation. Whichever type is employed, it is configured to be extracted in a sheet form from the interior of the barrel 503 through the slot 507 and wrapped about the drum cartridge surface 505 as illustrated by region 502A of the paper. A known manner clamping mechanism 601 holds the picked and extracted sheet 502A leading edge against drum cartridge surface 505. The print media hub 600 has an axle shaft 602 therethrough which is aligned with end cap 509, 511 apertures 517. Note also that multiple print length surface wrap embodiments can be implemented.

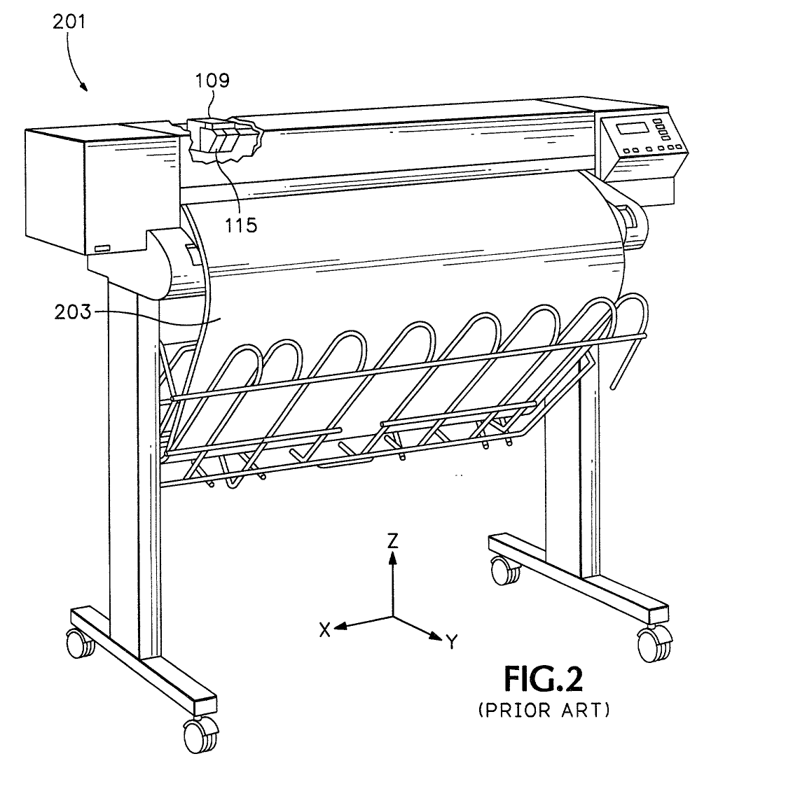

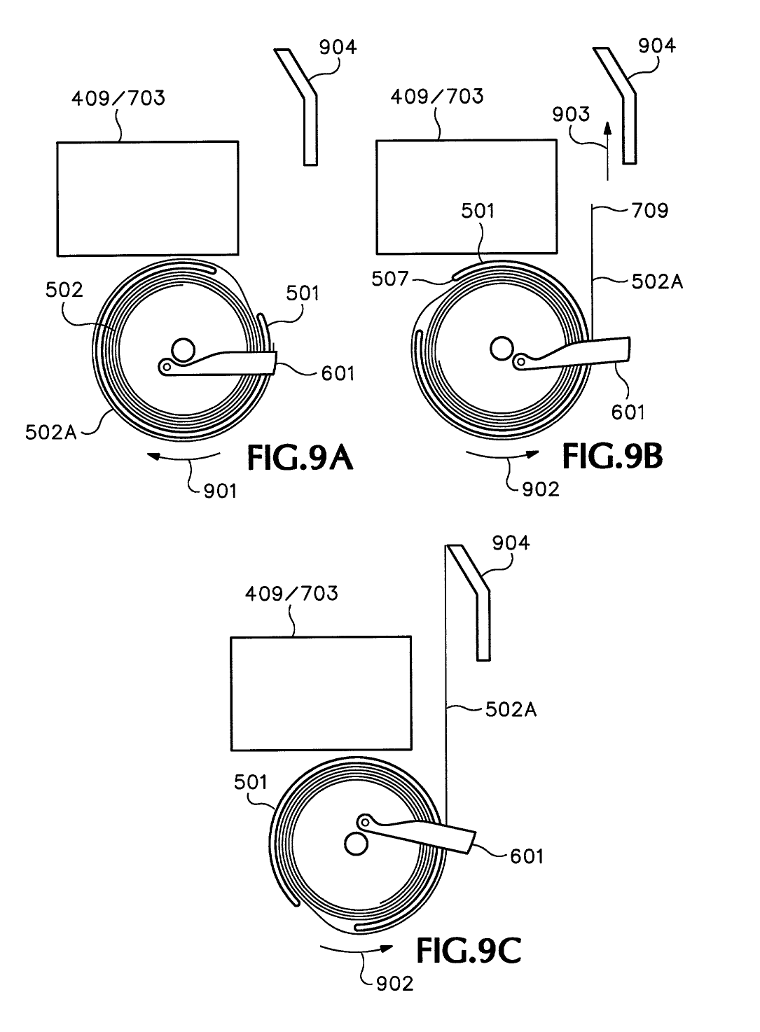

FIG. 7A is a top view schematic depiction of the printing media drum cartridge 501 mounted via axle shaft 602 (FIG. 6) and end cap apertures 517 (FIG. 5) on an axle 701 of an adapted hard copy apparatus and suitably mounted therein adjacent a writing instrument (e.g., element 409 of FIG. 4). FIG. 7B is a side elevation view of FIG. 7A. In this alternative embodiment, the writing instrument is an exemplary ink-jet pen 703 having a printhead 705, mounted in a known manner (see the carriage 109, FIGS. 1 and 2)on slider bars 707 for translational scanning in the x-axis across at least the width, “W,” of the extracted sheet 502A wrapped circumferentially about the drum cartridge surface 505.

For an ink-jet implementation, where it is known that occasional servicing of printheads is required, an optional spittoon region 711 (such as an absorbent pad) for nozzle spitting between printing cycles can be incorporated into the gap region, “G,” of the drum surface 505 between the clamped leading edge 709 of the wrapped sheet 502A and printable trailing edge 713—e.g., a perforated tear line—of the extracted sheet. In a disposable drum cartridge implementation, this provides an additional advantage of having waste ink removed from the printer environment with each print media cartridge.

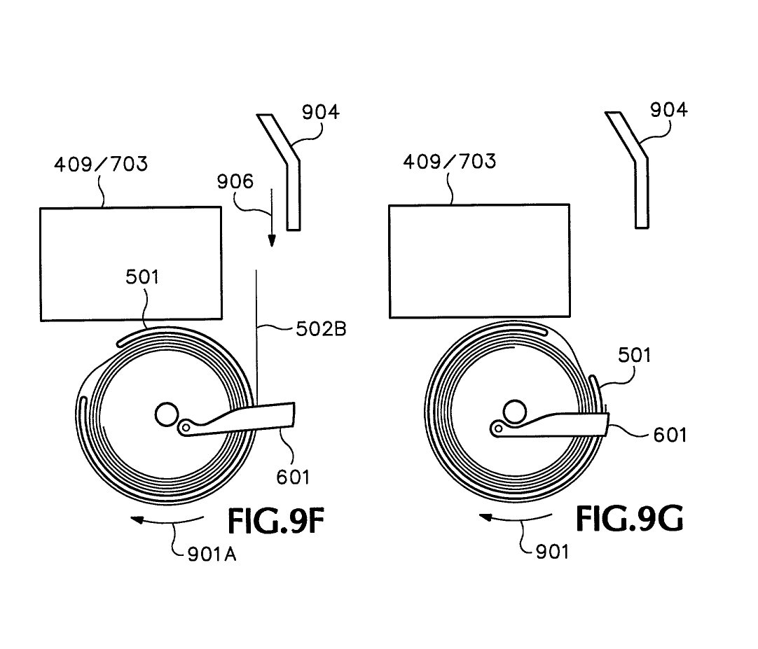

The leading edge 709 of sheet 502A wrapped about the drum surface 505 is captured and held against the drum cartridge surface by the clamping mechanism 601 which can be, for example an arm mounted and cammed in a known manner to move, arrow 715, in coordination with the drum cartridge rotation, arrow 717, about the axle 701 (this is further explained with respect to FIGS. 9A-9G). Other known manner mechanisms, such as pinch rollers or the like as would be known in the art, for temporarily securing the leading edge 709 may be employed in accordance with the present invention.

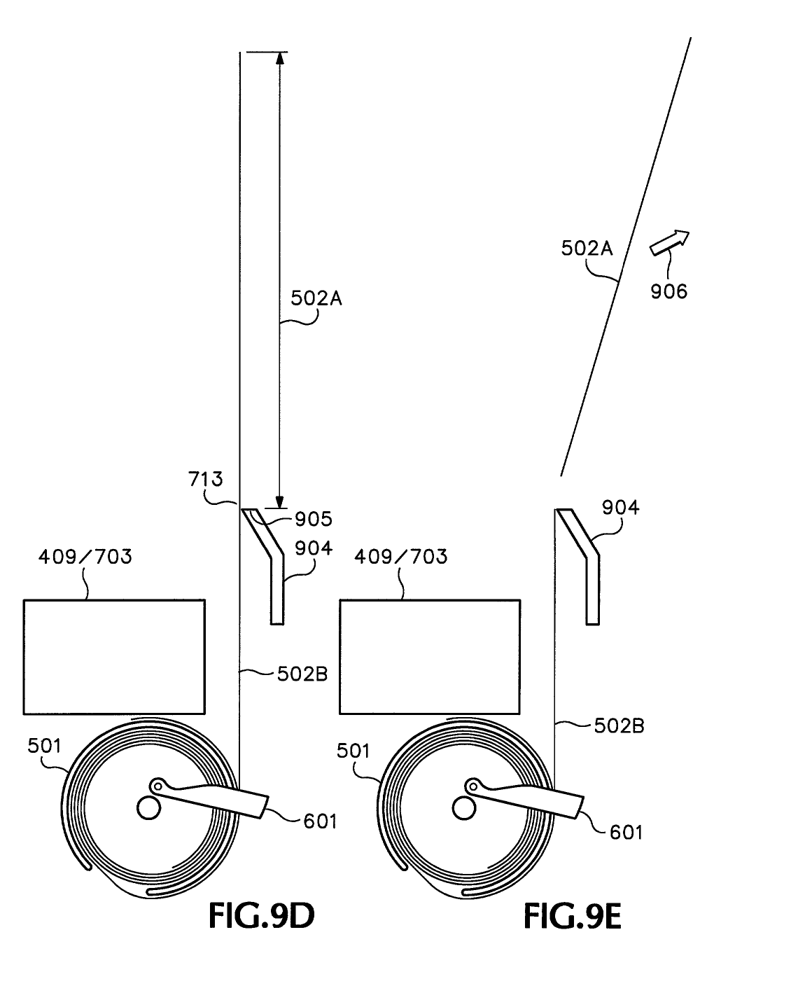

Referring to FIG. 7A and FIG. 8, the drum or the media or both can be provided with informational markings 801. These markings 801 are to provide location information and media information for the controller 102 (FIG. 1) and the printing device driver software as would be known to a person skilled in the art. The distance,“D,” between light and dark—transitions e.g., leading edge to leading edge—is kept constant which provides a speed control timing mechanism for a known manner optical sensor 719 associated with the controller 102 and driver software. The width of the dark bars 801 is variable. The sequence of wide bars 801′ and narrow bars—often referred to in the art as a “bar code”—produces the encoding of other information, such a medium type and quantity. Providing marks on both the media and the drum as shown in FIG. 7A allows for locating the media code in a determinable relationship to the drum's features, giving an paper encoded, index feature 803 for locating or adjusting the actual printing operation. The coding method used in any particular implementation of the present invention would require sufficient redundancy so that a decoding method can reliably recognize a start and stop of the coded information which in turn is used to locate the printing region on a wrapped sheet for the next print data. Moreover, special bar widths not used in the coding scheme could be detected and used for other purposes for a specific implementation. As examples, the printer might use the medium information to optimize printing by adjusting the immediate print mode for each new code, indicating type and size automatically; page numbers could be encoded and used to indicate when the remaining quantity with the drum is nearing an end. Other methods of timing on the drum can be employed—e.g., the use of known position reflectors, black-out regions, holes for a transmissive type sensor, and the like as would be known in the art. Note also that this could enable a first length of paper to have a header which defines the control and printing information for the whole roll.

In another alternative, such as a dedicated printer as shown in FIG. 3, a disk with timing marks can be made an integral part of the printer fixedly mounted with respect to axle the cartridge 701 (FIGS. 7A and 7B) wherein the drum cartridge is simplified and manufactured at lower costs, needing only mechanical features that mate to the disk in a consistent manner. Such an implementation would require another mechanism for reading additional information provided on the drum itself or on the media.

In another alternative embodiment, the cylindrical construct cartridge maybe designed to be permanent and refillable. A supplied roll of paper on a disposable hub 600 (FIG. 6) can be accompanied by an end cap 511, FIG. 7A, adapted for a predetermined positional attachment to the cartridge and bearing appropriate operational information encoded thereon for the new roll.

An exemplary embodiment for a low cost implementation using manual picking and feeding of paper is shown in FIGS. 9A-9G. Such an embodiment would be particularly useful in a portable environment or a child's toy printer where simplicity is a key design factor. Referring to FIG. 9A, a scanning writing instrument 409 (FIG. 4)—in this example, ink-jet pen 703—has a translational movement across the drum 501 (into the page) with the centerline of the pen's printhead nozzles approximately tangential to the drum as the drum rotates in the direction of the arrow 901. In FIG. 9A, a printing job has been completed on a sheet length of print media from the paper supply 502; that is, a finished print 502A is still wrapped about the drum cartridge surface, with its leading edge under clamp 601.

Referring now to FIG. 9B, the drum 501 rotation is reversed as indicated by the arrow 902. In this simple exemplary embodiment this is effected by merely pulling the clamp 601 outwardly away from the drum surface; it will be recognized by those skilled in the art that known manner, mechanical, directional biasing can be employed but that the concept can be expanded to an automated, partial or full print removal and media advance mechanism with known technology. The finished print 502A is unrolled from the outer surface of the drum 501 by pulling in the direction of the arrow 903 in the direction of a tear bar 904 associated with the printer apparatus.

Turning to FIG. 9C, the finished print 502A is pulled until the drum 501 and clamp 601 are positioned to lock the drum—again, in any known manner—from further rotation in the direction of arrow 902. Note that as the paper supply 502 is connected to the trailing edge of the print 502A as discussed above, the further pulling of the print extracts a next length 502A of paper from the interior of the drum 501 via the aperture 507 as demonstrated by FIG. 9C. The finished print 502A is pulled past the tear bar 904 until the trailing edge 713 of the print is positioned with a knife edge 905 of the tear bar as shown in FIG. 9D. As illustrated by FIG. 9E, the finished print 502A is torn off and removed as indicated by the arrow 906.

Referring to FIG. 9F, the drum 501 rotates back (arrow 901A) toward a position for rendering the next print. The next paper length 502B is retrieved (arrow 906) and wound onto the drum's outer surface. Rotation continues until the clamp 601 closes on the leading edge of what has now automatically become the current length of paper for printing as demonstrated in FIG. 9G. The next printing operation can now be started.

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. It can be recognized that the cartridge 501 can be adapted to many design implementation and can be either a disposable and replaceable or refillable. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

What is claimed is:

1. A print media cartridge device comprising:
a supply of print media in a substantially cylindrically containable form;
containing means for containing the supply of print media in an interior chamber of the containing means,
wherein the containing means is a substantially cylindrical construct having an outer surface for sequentially receiving at least one sheet of the supply thereon from within the containing means via an aperture coupling the outer surface to the interior chamber; and
mounting means for mounting the print media cartridge device adjacent means for printing on the print media of a hard copy apparatus adapted for using the device.

2. The device as set forth in claim 1, comprising:
holding means for releasably securing a leading edge of a sheet extracted from the chamber against the outer surface such that the sheet is wrapped securely around the outer surface and such that the media is positioned for printing thereon.

3. The device as set forth in claim 1, comprising:
the containing means having a means for coordinating timing of the printing on the media.

4. The device as set forth in claim 1, comprising:
the supply of media having a means for coordinating timing of the printing on each individual sheet thereof.

5. The device as set forth in claim 1, comprising:
the supply of media having on each individual sheet thereof a readable means for providing information regarding the supply.

6. The device as set forth in claim 1, comprising:
the containing means having a first means for coordinating timing of the printing on the media, and
the supply of media having a second means for coordinating timing of the printing on each individual sheet thereof.

7. The device as set forth in claim 6, comprising:
the first means for coordinating timing and the second means for coordinating timing are indexed relative to each other when the sheet is wrapped securely around the outer surface.

8. The device as set forth in claim 1, comprising:
the outer surface forming a platen for the sheet wrapped there around wherein the leading edge is separated from a trailing edge of the sheet by a surface region of the outer surface of a predetermined radial arc of the cylindrical construct.

9. The device as set forth in claim 8, comprising:
a writing instrument servicing region on the surface region within the predetermined radial arc between the leading edge and the trailing edge.

10. The device as set forth in claim 1, comprising:
the containing means is refillable wherein a refill supply of print media includes readable means for indicating control information specifically associated with the refill supply.

11. The device as set forth in claim 1, comprising:
the containing means is refillable wherein a refill unit includes a replacement supply of print media and a containing means mountable encoded means for providing print media control information regarding the replacement supply.

12. The device as set forth in claim 1, comprising:
the device is a disposable unit.

13. A hard copy apparatus comprising:
a writing instrument;
mounted adjacently to the writing instrument, a removable, rotating drum platen having an outer surface, the outer surface including an aperture of a width sufficient for passing print media therethrough;
a supply of print media contained within the drum in an orientation for continuously, sequentially feeding print media through the aperture such that at least one sheet length of the print media is wrapped around the drum platen when extracted from the drum;
means for temporarily securing a leading edge of the sheet length wrapped around the drum platen to the outer surface such that the sheet length is positioned with respect to the writing instrument for receiving colorant therefrom;
associated with the drum platen, means for encoding printing operation information; and
associated with the writing instrument, means for recognizing the information.

14. The apparatus as set forth in claim 13, further comprising:
means for severing the sheet length from the supply such that severing the sheet length extracts a next sheet length from the supply for positioning the next sheet length about the outer surface.

15. The apparatus as set forth in claim 13, comprising:
the rotating drum platen and supply of print media is a replaceable unit.

16. The apparatus as set forth in claim 15, comprising:
the replaceable unit includes means for identifying the drum platen and supply of print media therein and for providing printing control information with respect to the drum platen and supply of print media therein.

17. The apparatus as set forth in claim 13, comprising:
the rotating drum platen is refillable with a refill supply of print media.

18. The apparatus as set forth in claim 17, comprising:
the refill supply of print media has each sheet length of media encoded with information appurtenant to printing thereon wherein the information is readable by the means for recognizing.

19. A method of providing print media to a rotating drum type hard copy apparatus comprising the steps of:
providing the apparatus with a replaceable rotating drum construct mountable on the apparatus and having a supply of print media contained within the drum construct, wherein the supply of print media is in a form wherein the media is extractable from within the drum construct via an aperture in an outer surface of the drum, the outer surface configured for holding predetermined lengths of the media extracted from within the drum construct such that the surface forms a printing platen in the apparatus; and
periodically replacing the rotating drum construct with a rotating drum construct cartridge having a replacement supply of print media therein.

20. The method as set forth in claim 19, further comprising the step of:
encoding the rotating drum construct with printing control information decodable by the apparatus.

21. The method as set forth in claim 19, further comprising the step of:
encoding the replacement supply of print media with printing control information decodable by the apparatus.

22. A method of providing print media to a rotating drum type hard copy apparatus comprising the steps of:
providing the apparatus with a refillable rotating drum construct mountable on the apparatus and having a supply of printing media contained within the drum construct, wherein the supply of printing media is in a form wherein the media is extractable from within the drum construct via an aperture in an outer surface of the drum, the outer surface configured for holding predetermined lengths of the media extracted from within the drum construct such that the surface forms a printing platen in the apparatus; and
periodically replacing the supply of printing media drum within construct with a replacement supply of print media therein.

23. The method as set forth in claim 22, the step of periodically replacing the supply of printing media further comprises:
providing the replacement supply with encoded information readable by the apparatus for identifying and controlling printing on the replacement supply.

24. A method of producing hard copy comprising the steps of:
a) providing a drum platen with an internal supply of a continuous printing medium;
b) extracting through the drum platen a first length of printing medium from the supply by a leading edge;
c) wrapping the first length about the drum platen;
d) securing the leading edge of the first length to the drum platen proximate a trailing edge of the first length;
e) printing on the first length by rotating the drum platen in a first direction passed a writing instrument;
f) releasing the leading edge;
g) pulling the first length away from the drum platen wherein the drum platen is rotated in a second direction opposite the first direction;
h) stop locking the drum platen in a predetermined position wherein the step of pulling further extracts a next length of printing medium from within the drum platen;
i) separating the first length from the next length;
j) rotating the drum platen in the first direction such that the next length is wrapped around the drum platen;
k) securing the leading edge of the next length to the drum platen proximate a trailing edge of the next length; and
l) repeating steps e) through k) for each hard copy to be produced.

25. The method as set forth in claim 24, comprising the further steps of:
m) encoding the drum platen with printing control information.

26. The method as set forth in claim 24, comprising the further steps of:
n) when the continuous medium is depleted, replacing the medium.

27. The method as set forth in claim 26, wherein the step of replacing the medium comprises:
o) replacing the drum platen with internal supply of printing medium as a unit.

28. The method as set forth in claim 26, comprising the further steps of:
p) refilling the drum platen with a refill supply of printing medium.

29. The method as set forth in claim 24, comprising the further steps of:
q) encoding the printing medium with printing control information.
